(19) United States
(12) Patent Application Publication
(10) Pub. No.: US 2019/0335704 A1
(43) Pub. Date: Nov. 7, 2019

(54) Flexible Pet Cage

(71) Applicant: Kurt B. Burkhart, New Holland, PA (US)

(72) Inventor: Kurt B. Burkhart, New Holland, PA (US)

(21) Appl. No.: 16/403,783

(22) Filed: May 6, 2019

Related U.S. Application Data
(60) Provisional application No. 62/667,657, filed on May 7, 2018.

(51) Int. Cl. A01K 1/03; A47C 7/62; A47C 4/28

(52) U.S. Cl. CPC A01K 1/03; A47C 1/14; A47C 4/28; A47C 7/626

(57) ABSTRACT

A flexible pet cage for use with an outdoor chair. The pet cage includes an upper wall, a forward wall, two sidewalls, and a rear wall that form an enclosure with an open bottom. The walls are comprised of a breathable, durable mesh material, and the pet cage is configured to reversibly attach to the outdoor chair and occupy a space thereunder. Upon reversibly attaching the pet cage to the outdoor chair, the pet cage may be used to house a pet therein, or may be folded up along with the outdoor chair for transport or storage.

### CROSS REFERENCE TO RELATED APPLICATIONS

This application claims priority under 35 U.S.C. § 119(e) to U.S. Provisional Application No. 62/667,657 filed on May 7, 2018. The above identified patent application is incorporated by reference herein in its entirety to provide continuity of disclosure.

### BACKGROUND OF THE INVENTION

The present invention relates to a flexible pet cage for use with a foldable chair to secure a pet therein.

Many pet owners have pets which spend the majority of their time indoors, such as cats. Cats may be difficult to train, and may wander or become lost if left in an outdoor environment, such as a yard or a porch. On many occasions, these pet owners may desire for a pet cat to be able to sit or lay outdoors with them, for the animal to receive fresh air and a degree of sunlight to improve or maintain the health of the animal, and for the enjoyment of the pet owner. Existing solutions for housing animals outdoors may be inconvenient or difficult to move to transport.

Therefore, there is a need in the art for a flexible and portable pet cage for use with a chair, such as an outdoor chair, to secure a pet therein within an outdoor environment. The present invention addresses this unmet need.

Devices have been disclosed in the art that relate to pet cages. These include devices that have been patented and published in patent application publications. These devices are often difficult to move to transport. In view of the devices disclosed in the art, it is submitted that there is a need in the art for an improvement to existing pet cages. In view of the present disclosure, it is submitted that the present invention substantially diverges in structural and functional elements from devices in the art, and substantially fulfills an unmet need.

### SUMMARY OF THE INVENTION

In view of the disadvantages inherent in the known types of pet cages in the art, the present invention provides a new and improved flexible pet cage, wherein the same can be utilized for housing an animal, such as a pet, in an outdoor environment.

It is therefore an object of the present invention to provide a flexible pet cage for use with a chair, wherein the flexible pet cage is foldable along with the chair upon attachment of the flexible pet cage to the chair.

In one aspect, the present invention provides a flexible pet cage, comprising: a plurality of walls, comprising an upper wall, a forward wall, a left sidewall, a right sidewall, and a rear wall; wherein the plurality of walls comprises a mesh material; wherein the flexible pet cage is reversibly attachable to a chair, such that upon attachment of the flexible pet cage to the chair, the flexible pet cage occupies a space underneath the chair.

In some embodiments, each wall of the plurality of walls comprises the mesh material.

In some embodiments, the chair is foldable such that upon attachment of the flexible pet cage to the chair and upon a folding of the chair, the flexible pet cage is folded within a portion of the chair. In some such embodiments, the portion of the chair comprises a space between a forward leg of the chair and a rearward leg of the chair.

In some embodiments, the right sidewall comprises a forward portion and a rearward portion, wherein the forward portion is reversibly attachable to the rearward portion. In some such embodiments, the forward portion of the right sidewall is reversibly attachable to the rearward portion of the right sidewall by a zipper.

In some embodiments, the flexible pet cage is reversibly attachable to a forward leg and a rearward leg of the chair. In some such embodiments, a selection of walls of the plurality of walls is securable to the forward leg and the rearward leg of the chair by one or more hook and loop fasteners. In some such embodiments, a forward edge of the upper wall is reversibly attachable to an upper edge of the forward wall by an attachment mechanism, which may be, for example, a hook and loop fastener.

In various embodiments, the flexible pet cage does not include a bottom or lower wall. In this manner, the pet can enjoy a ground of an environment in which the flexible pet cage is placed, which may comprise grass, dirt, water, and other environmental elements that may enhance the quality of the time spent outdoors by the pet.

In particular embodiments, the chair includes an outdoor chair. In other particular embodiments, the chair includes a foldable chair. In particular, the chair is a foldable outdoor chair. In like manner, the flexible pet cage may be designed for use outdoors.

Another object of the present invention is to provide a flexible pet cage that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1A depicts a perspective view of an exemplary flexible pet cage reversibly attached to a chair.

FIG. 1B depicts a perspective view of the exemplary flexible pet cage, in an assembled state, depicted without the chair.

FIG. 2A depicts a top view of the exemplary flexible pet cage in an unassembled state.

FIG. 2B depicts a perspective view of the exemplary flexible pet cage, with the chair placed on a portion of the flexible pet cage as part of a method of reversibly attaching the flexible pet cage to the chair.

FIG. 2C depicts a lower perspective view of the exemplary flexible pet cage being reversibly attached to the chair, wherein a forward wall and a rearward wall are being wrapped around a forward leg and a rearward leg of the chair, respectively.

FIG. 2D depicts a lower perspective view of the exemplary flexible pet cage being reversibly attached to the chair, wherein a forward portion of a right sidewall is wrapped around to meet a rearward portion of the right sidewall.

FIG. 2E depicts a lower perspective view of the exemplary flexible pet cage being reversibly attached to the chair, wherein a forward edge of an upper wall is being folded over to meet an upper edge of the forward wall.

FIG. 2F depicts a close-up perspective view of the flexible pet cage after reversible attachment to the chair.

FIG. 3 depicts a perspective view of the chair with the flexible pet cage reversibly attached thereto, in an extended configuration (left) and in a folded configuration (right).

### DETAILED DESCRIPTION OF THE INVENTION

Reference is made herein to the attached drawings. Like reference numerals are used throughout the drawings to depict like or similar elements of the invention. The figures are intended for representative purposes only and should not be considered limiting in any respect.

Reference is now made to the drawings, which depict one or more exemplary embodiments of the invention.

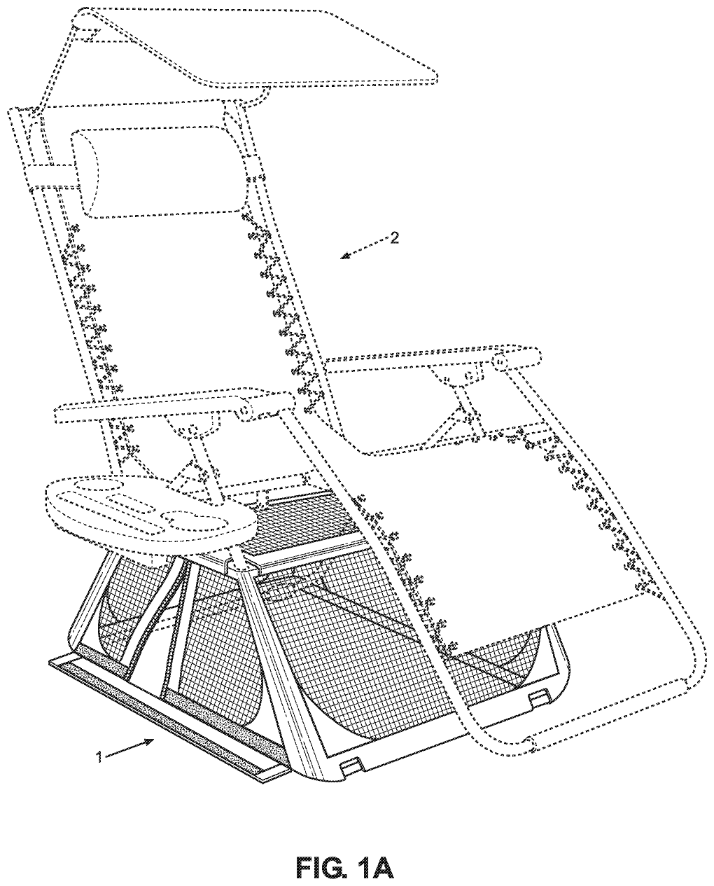

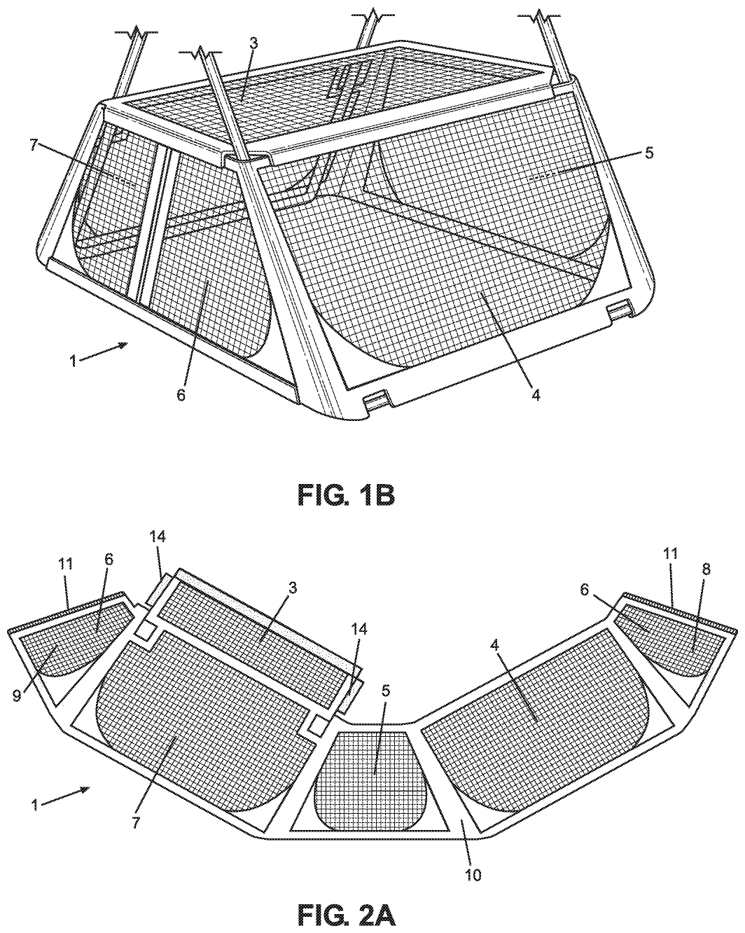

Referring now to FIG. 1A, there is depicted a perspective view of an exemplary flexible pet cage reversibly attached to a chair. The flexible pet cage 1 includes an opening positioned on one of the sidewalls (e.g., a right sidewall, as shown) which is securable in a closed configuration with a zipper, or releasable in an open configuration (as shown) with the zipper. In the shown embodiment, the flexible pet cage 1 does not include a lower or bottom wall, and in this manner, a pet placed therein is able to interact with a ground of an environment containing the flexible pet cage 1.

Generally, the flexible pet cage 1 is sized and configured to fit underneath a chair, such as a chair 2, as shown. As shown and described elsewhere herein, the flexible pet cage 1 is sufficiently flexible so as to enable an individual to reversibly attach the flexible pet cage 1 to the chair 2, and to fold up the chair 2 without removing the flexible pet cage 1 from the chair 2. In this manner, the individual need not worry about attaching or detaching the flexible pet cage 1 to or from the chair 2 between uses, and the utility and the convenience of the flexible pet cage 1 are maximized.

In various embodiments, the walls of the flexible pet cage 1 are comprised of a durable mesh material that may be water proof, water resistant, and/or resistant to scratching or wearing that may otherwise occur due to scratching by a pet, such as a cat, positioned therein. The durable mesh material may comprise a suitable fabric. In the shown embodiment, the mesh material of the walls of the flexible pet cage is surrounded by a support liner that adds additional support at the areas of the flexible pet cage 1 that interact with the legs of the chair 2, as shown and described elsewhere herein.

Referring now to FIG. 1B, there is depicted a perspective view of the exemplary flexible pet cage, in an assembled state, depicted without the chair. In the shown embodiment, the flexible pet cage comprises a plurality of walls, comprising an upper wall 3, a forward wall 4, a left sidewall 5, a right sidewall 6, and a rear wall 7. In the shown embodiment, the plurality of walls comprises the mesh material, and the flexible pet cage 1 is reversibly attachable to a chair, such that upon attachment of the flexible pet cage 1 to the chair, the flexible pet cage 1 occupies a space underneath the chair. In the shown embodiment, each wall of the plurality of walls comprises the mesh material, and in this manner, an airflow and a penetration of sunlight through the flexible pet cage 1 are maximized.

In the shown embodiment, the forward wall 4 includes a pair of rectangular apertures on the support liner thereof, such that a portion of a forward leg of a chair is visible when the flexible pet cage 1 is attached thereto. In addition, in the shown embodiment, the upper wall 3 includes a pair of triangular apertures on the support liner thereof, and the rear wall 7 includes a pair of square or rectangular apertures on the support liner thereof. These apertures may function to facilitate airflow through the flexible pet cage 1.

In the shown embodiment, the support liner of the forward wall 4, the left sidewall 5, the right sidewall 6, and the rear wall 7 each comprises a pair of arcuate corner supports. The corner supports are provided in the shown embodiment as additional structural support to the walls (4, 5, 6, 7), and in this manner, an animal kept or to be kept inside the flexible pet cage 1 is unable to escape by pulling or tearing on the walls (4, 5, 6, 7).

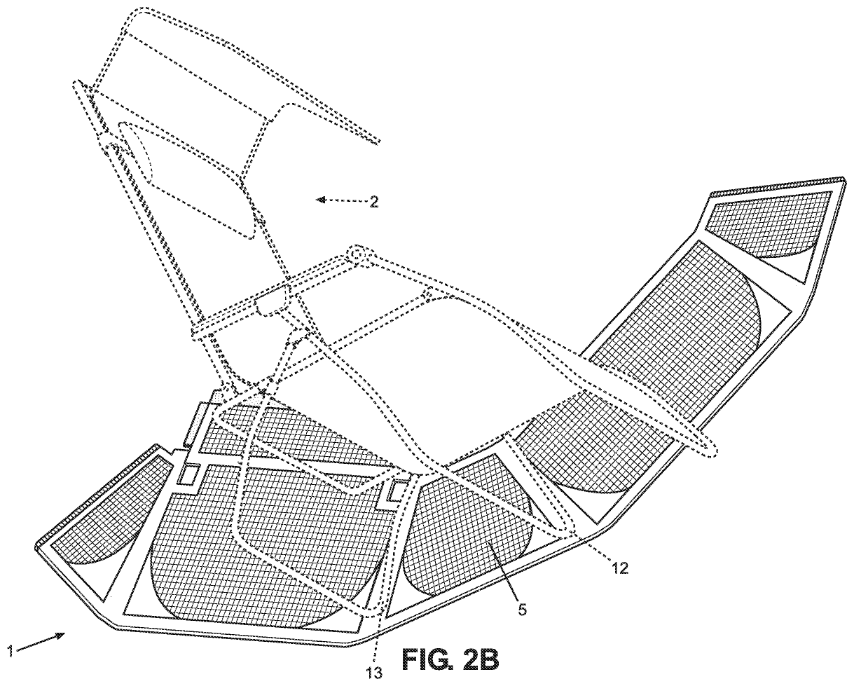

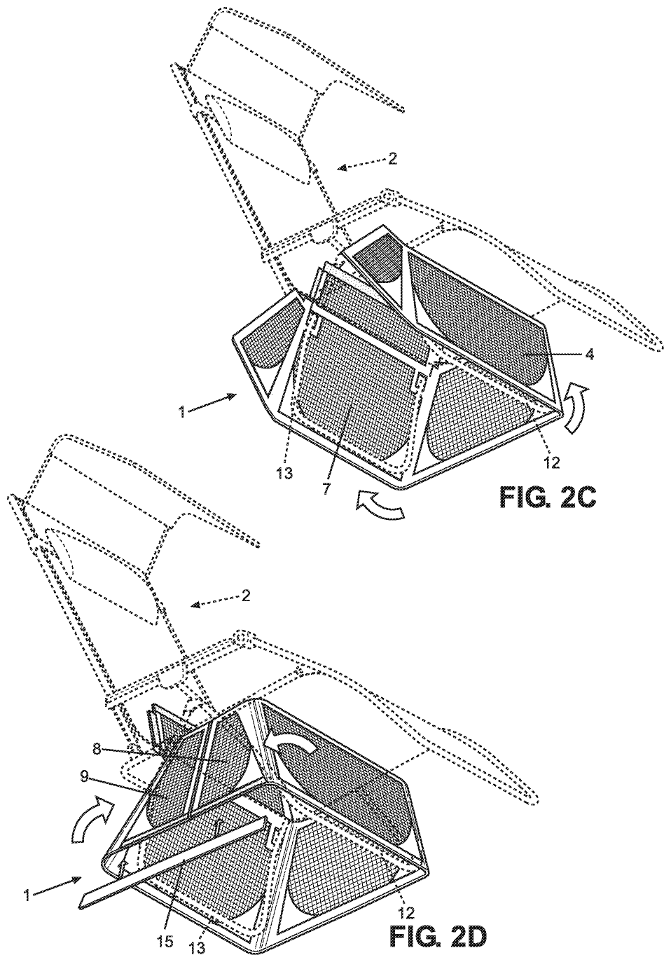

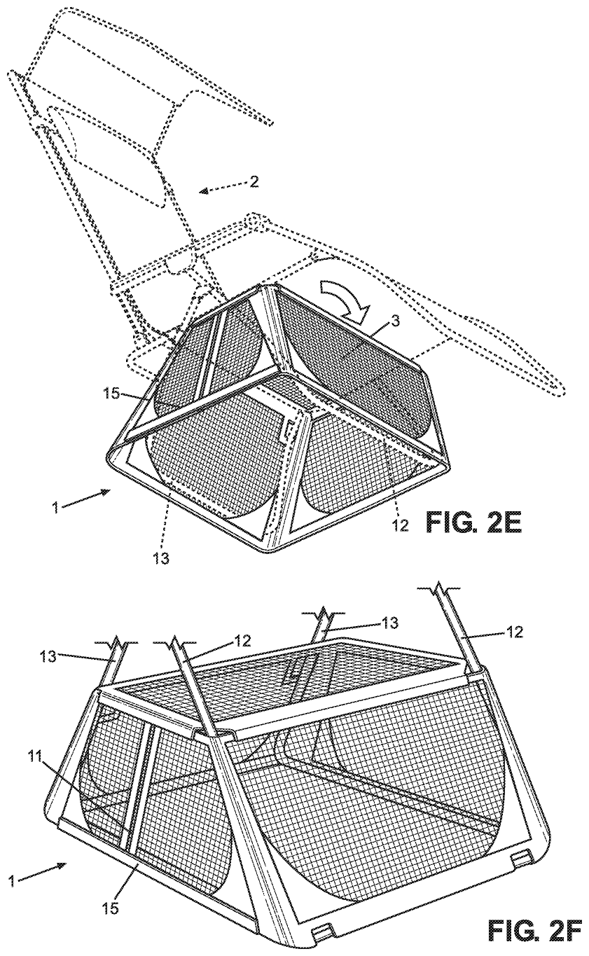

Referring now to FIG. 2A, there is depicted a top view of the exemplary flexible pet cage in an unassembled state. In the shown embodiment, the exemplary flexible pet cage 1 is unfolded or unfurled in a flat configuration to illustrate how the walls of the plurality of walls relate to one another from a structural perspective.

In the shown embodiment, the upper wall 3 is affixed to the rear wall 7, which is in turn affixed to a rearward portion 9 of the right sidewall 6 on a rightward edge thereof, and affixed to the left sidewall 5 on a leftward edge thereof. The left sidewall 5 is affixed to the forward wall 4 along a forward edge thereof, which is in turn affixed to a forward portion 8 of the right sidewall 6 on a right edge thereof. The rearward portion 9 and the forward portion 8 are reversibly attachable by a zipper 11, and the upper wall 3 is reversibly attachable to the forward wall 4 by one or more attachments 14 (e.g., hook and loop attachments) of the upper wall 3. In the shown embodiment, the one or more attachments 14 includes two hook and loop attachments and a lengthwise hook and loop attachment positioned between attachments 14.

In the shown embodiment, a support liner 10 extends around every wall of the plurality of sidewalls so as to maximize a structural support or stability of the flexible pet cage. In addition, in the shown embodiment, the arcuate corner supports are included for additional structural stability. Generally, the overall structure of the flexible pet cage 1 is angled to configure the flexible pet cage to wrap around a pair of legs of a chair, such as an outdoor chair, such as a chair, as shown and described elsewhere herein.

Referring now to FIG. 2B, there is depicted a perspective view of the exemplary flexible pet cage, with the chair placed on a portion of the flexible pet cage as part of a method of reversibly attaching the flexible pet cage to the chair. To install the flexible pet cage 1 onto the chair 2, the flexible pet cage 1 is laid flat (see FIG. 2A). Then, the flexible pet cage 1 is laid on its side such that a left portion of each of a forward leg 12 and a rearward leg 13 of the chair 2 interacts with the support liner surrounding the left sidewall 5.

Referring now to FIG. 2C, there is depicted a lower perspective view of the exemplary flexible pet cage being reversibly attached to the chair, wherein a forward wall and a rearward wall are being wrapped around a forward leg and a rearward leg of the chair, respectively. After laying the chair 2 on the flexible pet cage 1, the rear wall 7 and the forward wall 4 are wrapped or folded around the rearward leg 13 and the forward leg 12, respectively.

Referring now to FIG. 2D, there is depicted a lower perspective view of the exemplary flexible pet cage being reversibly attached to the chair, wherein a forward portion of a right sidewall is wrapped around to meet a rearward portion of the right sidewall. After folding the rear wall and the forward wall around the legs of the chair, the rearward portion 9 and the forward portion 8 of the right sidewall are folded together and reversibly attached by the zipper. In this manner, the legs (12, 13) of the chair are substantially surrounded by the flexible pet cage 1. In the shown embodiment, a lower zipper fastener 15 is included. The lower zipper fastener is placed on a lower edge of the right sidewall to secure the zipper of the right sidewall in a closed configuration. The lower zipper fastener 15 may include a hook and loop fastener, and is configured to wrap around an inside and an outside of the lower edge of the right sidewall.

Referring now to FIG. 2E, there is depicted a lower perspective view of the exemplary flexible pet cage being reversibly attached to the chair, wherein a forward edge of an upper wall is being folded over to meet an upper edge of the forward wall. After securing the rearward portion of the right sidewall to the forward portion of the right sidewall, the upper wall 3 is secured to the forward wall by one or more hook and loop attachments. In the shown embodiment, the lower zipper fastener 15 has been attached to the lower edge of the right sidewall. In this manner, the flexible pet cage is configured to secure a pet therein.

Referring now to FIG. 2F, there is depicted a close-up perspective view of the flexible pet cage after reversible attachment to the chair. In the shown embodiment, the flexible pet cage 1 has been secured to the forward leg 12 and the rearward leg 13 of the chair, and secured in place by the zipper 11 and the lower zipper fastener 15. In various embodiments, the attachments lower zipper fastener 15 comprises hook and loop attachment straps, or an equivalent fastener suitable for the purpose. In the shown embodiment, the zipper 11 is in a closed configuration to keep a pet placed within the flexible pet cage 1.

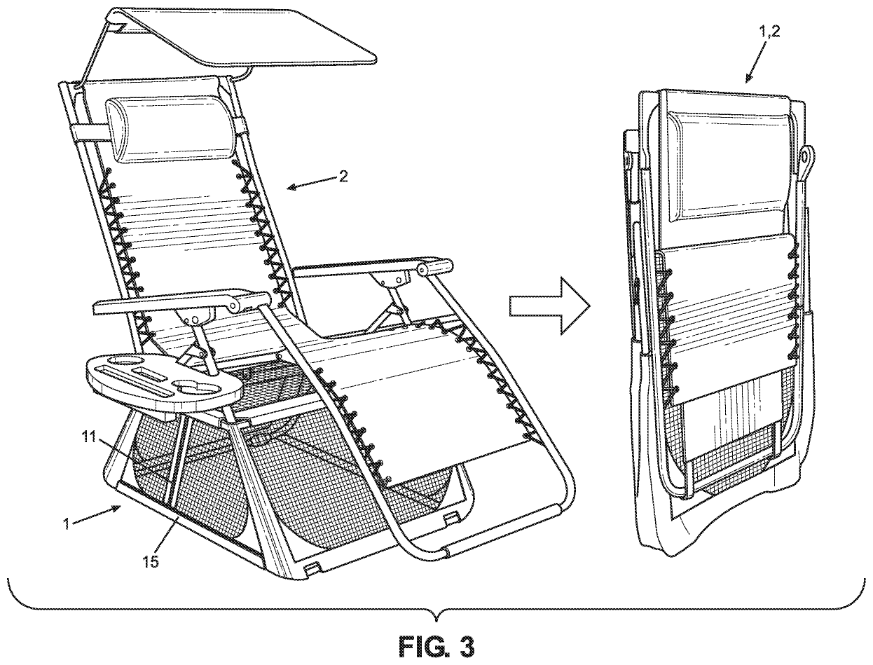

Referring now to FIG. 3, there is depicted a perspective view of the chair with the flexible pet cage reversibly attached thereto, in an extended configuration (left) and in a folded configuration (right). Generally, the flexible pet cage 1 is sufficiently flexible and/or foldable so as to configure the flexible pet cage 1 to be stowable within the chair 2 when the chair 2 is in a folded configuration. In the shown embodiment, the zipper 11 and the lower zipper fastener 15 are in the closed configuration, and in this manner, the flexible pet cage 1 is configured to hold the pet therein during use.

In the shown embodiment, the legs of the chair are inserted into the support liners of the flexible pet cage 1. In this manner, if the chair 2 is slid or moved on a surface, such as a floor or a ground outdoors, the flexible pet cage remains attached to the chair 2 and a stability of the flexible pet cage 1 is maximized. In the shown embodiment, the chair 2 is foldable such that upon attachment of the flexible pet cage 1 to the chair 2 and upon a folding of the chair 2, the flexible pet cage 1 is folded within a portion of the chair 2. In the shown embodiment, the portion of the chair 2 comprises a space between a forward leg of the chair 2 and a rearward leg of the chair 2. In this manner, during use, the pet is kept within the flexible cage 1, where it is safe and cannot wander off or become lost.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the present invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A flexible pet cage, comprising:
a plurality of walls, comprising an upper wall, a forward wall, a left sidewall, a right sidewall, and a rear wall;
wherein one or more walls of the plurality of walls comprises a mesh fabric material;
wherein the flexible pet cage is reversibly attachable to a chair, such that upon attachment of the flexible pet cage to the chair, the flexible pet cage occupies a space underneath the chair.

2) The flexible pet cage of claim 1, wherein each wall of the plurality of walls comprises the mesh material.

3) The flexible pet cage of claim 1, wherein the chair is foldable such that upon attachment of the flexible pet cage to the chair and upon a folding of the chair, the flexible pet cage is folded within a portion of the chair.

4) The flexible pet cage of claim 3, wherein the portion of the chair comprises a space between a forward leg of the chair and a rearward leg of the chair.

5) The flexible pet cage of claim 1, wherein the right sidewall comprises a forward portion and a rearward portion, wherein the forward portion is reversibly attachable to the rearward portion.

6) The flexible pet cage of claim 5, wherein the forward portion of the right sidewall is reversibly attachable to the rearward portion of the right sidewall by a zipper.

7) The flexible pet cage of claim 1, wherein the flexible pet cage is reversibly attachable to a forward leg and a rearward leg of the chair.

8) The flexible pet cage of claim 7, wherein a selection of walls of the plurality of walls is securable to the forward leg and the rearward leg of the chair by one or more hook and loop fasteners.

9) The flexible pet cage of claim 7, wherein a forward edge of the upper wall is reversibly attachable to an upper edge of the forward wall by an attachment mechanism.

10) The flexible pet cage of claim 9, wherein the attachment mechanism comprises a hook and loop fastener.

11) A flexible pet cage, comprising:
a plurality of walls, consisting of an upper wall, a forward wall, a left sidewall, a right sidewall, and a rear wall;
wherein one or more walls of the plurality of walls comprises a mesh fabric material;
wherein the flexible pet cage is reversibly attachable to a chair, such that upon attachment of the flexible pet cage to the chair, the flexible pet cage occupies a space underneath the chair.

12) The flexible pet cage of claim 11, wherein each wall of the plurality of walls comprises the mesh material.

13) The flexible pet cage of claim 11, wherein the chair is foldable such that upon attachment of the flexible pet cage to the chair and upon a folding of the chair, the flexible pet cage is folded within a portion of the chair.

14) The flexible pet cage of claim 13, wherein the portion of the chair comprises a space between a forward leg of the chair and a rearward leg of the chair.

15) The flexible pet cage of claim 11, wherein the right sidewall comprises a forward portion and a rearward portion, wherein the forward portion is reversibly attachable to the rearward portion.

16) The flexible pet cage of claim 15, wherein the forward portion of the right sidewall is reversibly attachable to the rearward portion of the right sidewall by a zipper.

17) The flexible pet cage of claim 11, wherein the flexible pet cage is reversibly attachable to a forward leg and a rearward leg of the chair.

18) The flexible pet cage of claim 17, wherein a selection of walls of the plurality of walls is securable to the forward leg and the rearward leg of the chair by one or more hook and loop fasteners.

19) The flexible pet cage of claim 17, wherein a forward edge of the upper wall is reversibly attachable to an upper edge of the forward wall by an attachment mechanism.

20) The flexible pet cage of claim 19, wherein the attachment mechanism comprises a hook and loop fastener.
